(19) United States
(12) Patent Application Publication
(10) Pub. No.: US 2015/0336033 A1
(43) Pub. Date: Nov. 26, 2015

(54) Filtration Article Containing A Filtration Material Having Twisted Pleats Therein

(71) Applicant: W. L. Gore & Associates, Inc., Newark, DE (US)

(72) Inventor: Edward T. Neitzel, Oxford, PA (US)

(73) Assignee: W. L. Gore & Associates, Inc., Newark, DE (US)

(21) Appl. No.: 14/284,702

(22) Filed: May 22, 2014

(51) Int. Cl. B01D 29/07; B01D 29/01

(52) U.S. Cl. CPC B01D 29/071; B01D 29/012

(57) ABSTRACT

A filtration device having therein a pleated, twisted filtration material is provided. The filtration material has a generally cylindrical shape and includes a first end, a second end opposing the first end, and outwardly projecting pleats. The pleats have a non-linear orientation within the filtration device. The twisting of the filtration material moves the ends of the pleats a distance around the circumference of the filtration material from a first position (P1) to a second position (P2). The angle of rotation may range from about 5 degrees to about 1440 degrees. Twisting the filtration material increases the effective amount of filtration material in the filtration device, which in turn, corresponds to an increase in the Effective Filtration Area (EFA). The intentional misalignment of the pleat ends in the filtration material improves the cutting ability of the material, removes buckling of the material, and improves the quality of the trim cut.

### FIELD

The present disclosure relates generally to filtration articles, and more specifically to a filtration cartridge that contains a twisted, pleated filtration material.

### BACKGROUND

Filtration cartridges are well known and are used in the filtration of particulate, ionic, microbial and other contaminants from fluids in pharmaceutical, microelectronics, chemical and food industries. Filtration cartridges typically include a filtration material that has a plurality of longitudinal pleats arranged in a cylindrical configuration, a perforated cage disposed about the outer periphery of the filter element to permit fluid entry into the cartridge, and a perforated core coaxially disposed within the filter material. End caps are positioned at the ends of the filter material to prevent the egress of fluid from the cartridge. The ends of the filtration material are typically sealed by potting the ends of the filtration medium in an end cap, the end cap being in the form of a resin, a molten thermoplastic, or the like during a potting step.

Many filtration devices are constructed entirely of fluoropolymer materials to meet chemical and temperature resistance requirements, such as for use in the fabrication of semiconductors. The filtration medium may include upstream and downstream drainage layers that are constructed of fluoropolymeric fiber materials (e.g., polytetrafluoroethylene (PTFE), perfluoroalkoxy alkane (PFA), and polyvinylidene fluoride (PVDF)) in the form of woven materials, non-woven materials, or nets. While such filtration media provide superior particle filtration, the flexible nature of these materials makes assembly of the filtration device difficult. For instance, the low stiffness of the filtration medium makes insertion of conventional filtration medium into the perforated cage difficult. Also, filtration media are manufactured to have a length that is greater than the length of the perforated cage so that the ends of the filtration medium may be trimmed to fit the length of the cartridge. However, the flexibility (e.g., non-rigidity) of the pleated filter medium makes it extremely difficult to cut, resulting in uneven edges and poor end capping.

Thus, there exists a need in the art for a filtration medium that is easy to cut and assemble into a filtration cartridge.

### SUMMARY

One embodiment of the invention relates to a filter cartridge assembly that includes an outer cage, a filtration material, an inner core member disposed within the filtration material, and end caps bonded to first and second ends of the filtration material. The filtration material has a generally cylindrical shape and includes a first end, a second end opposing the first end, and outwardly projecting pleats. In addition, the pleats have a non-linear orientation within the filter cartridge assembly. In particular, a pleat end at one end of the filter cartridge assembly has a second location at the opposing end of the filter cartridge assembly that correlates to the angle of rotation within the filtration material. The rotation or twisting of the filtration material moves the pleat at the second end a distance around the circumference of the filtration material to the second location. Also, the rotation of the filtration material increases the effective filtration area of the filter cartridge assembly. The angle of rotation may range from about 5 degrees to about 1440 degrees.

A second embodiment of the invention relates to a filter cartridge assembly that includes a cylindrical filtration material having pleats therein and which includes an outer periphery, an inner periphery, a first end surface, and a second end surface. An end cap is bonded to each of the first end surface and second end surface of the filtration material. The pleats may have a generally V-shaped configuration. Also, the filtration material may include a porous membrane, a fibrous layer, and a thermoplastic material. The fibrous layer is configured to support the porous membrane and/or is configured to provide drainage of fluid away from the membrane. The thermoplastic material is imbibed into filtration material along at least one end of the filtration material. Optionally, the filtration material may include a second fibrous layer. The pleats have an angle of rotation greater than about 5 degrees. The angle of rotation may be calculated using the following formula:

$$θ = 114.6 \sqrt{\frac{{L}_{m}^{2} - {L}_{c}^{2}}{{d}^{2}}}$$

where Lₘ is length of said filtration material,

where L_{c} is length of filter cartridge, and

where d is diameter of said filtration material.

A third embodiment of the invention relates to a method of forming a twisted, pleated filtration material that includes (1) twisting a first end of the filtration material relative to a second end of said filtration material and (2) calculating a twist angle formed between a first position of a designated pleat and a second position of said designated pleat utilizing the following formula:

$$θ = 114.6 \sqrt{\frac{{L}_{m}^{2} - {L}_{c}^{2}}{{d}^{2}}}$$

where Lₘ is length of filtration material,

where L_{c} is length of filter cartridge, and

where d is diameter of filtration material.

The pleats have an angle of rotation greater than about 5 degrees. Additionally, the pleats may have a generally V-shaped configuration. The filtration material may include a porous membrane, a fibrous layer, and a thermoplastic material.

A fourth embodiment of the invention relates to a method of forming a twisted, pleated filtration material that includes (1) obtaining a cylindrical filtration material and (2) rotating the second end of the filtration material relative to the first end about the longitudinal axis of the filtration material. Prior to twisting the filtration material, the pleats have a linear or substantially linear orientation along the length of the filtration material. Rotation of the filtration material moves the pleats at the second end a distance around the circumference of the filtration material to a second position that is no longer in alignment with the first position. After rotation, pleat ends have a location at the second end of the filtration material that correlates to the angle of rotation within the filtration material. The angle of rotation may range from about 5 degrees to about 1440 degrees.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is an exploded view of a filtration device containing a twisted, pleated filtration medium in accordance with an embodiment of the present invention;

FIG. 2A is a schematic illustration of layers of material within a filtration material where the porous membrane contains a single layer according to at least one embodiment of the present invention;

FIG. 2B is a schematic illustration of layers of material within a filtration material where the porous membrane contains multiple layers according to at least one embodiment of the present invention;

FIG. 3A is a schematic illustration of a conventional pleated filtration medium having V-shaped pleats that are positioned about and extend linearly along a longitudinal axis from end to end of the filtration material;

FIG. 3B is a schematic illustration of a twisted, pleated filtration medium having V-shaped pleats that are positioned about and extend non-linearly along a longitudinal axis from end to end of the filtration material according to at least one embodiment of the present invention;

FIG. 4A is a schematic cross-sectional view of a filtration device depicting a filtration material prior to twisting in which the pleats are aligned along a longitudinal axis from a first end to a second end of the filtration device;

FIG. 4B is a schematic cross-sectional view of a filtration device with a twisted filtration medium showing the movement of a pleat from a first point to a second point after the filtration medium has been twisted according to one embodiment of the invention;

FIG. 5A is a schematic perspective view of a filtration device having a non-twisted filtration material showing alignment of the pleats along a longitudinal axis from a first end to a second end of the filtration device;

FIG. 5B is a schematic perspective view of a filtration device having a twisted filtration medium showing the movement of a pleat from a first point to a second point after the filtration medium has been twisted according to one embodiment of the invention;

FIG. 6 is an exploded view of a conventional filtration device containing a non-twisted, pleated filtration material; and

FIG. 7 is a photograph showing a conventional filtration cartridge superposed with a dashed line illustrating the buckling of the filtration material within the cartridge.

### DETAILED DESCRIPTION

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

The terms “rotating” and “rotated” may be used interchangeably with “twisting” and “twisted”, respectively. In addition, the terms “filtration material” and “filtration medium” may be interchangeably used herein. Also, “fibrous layer” and “fiber layer” may be used interchangeably in this application.

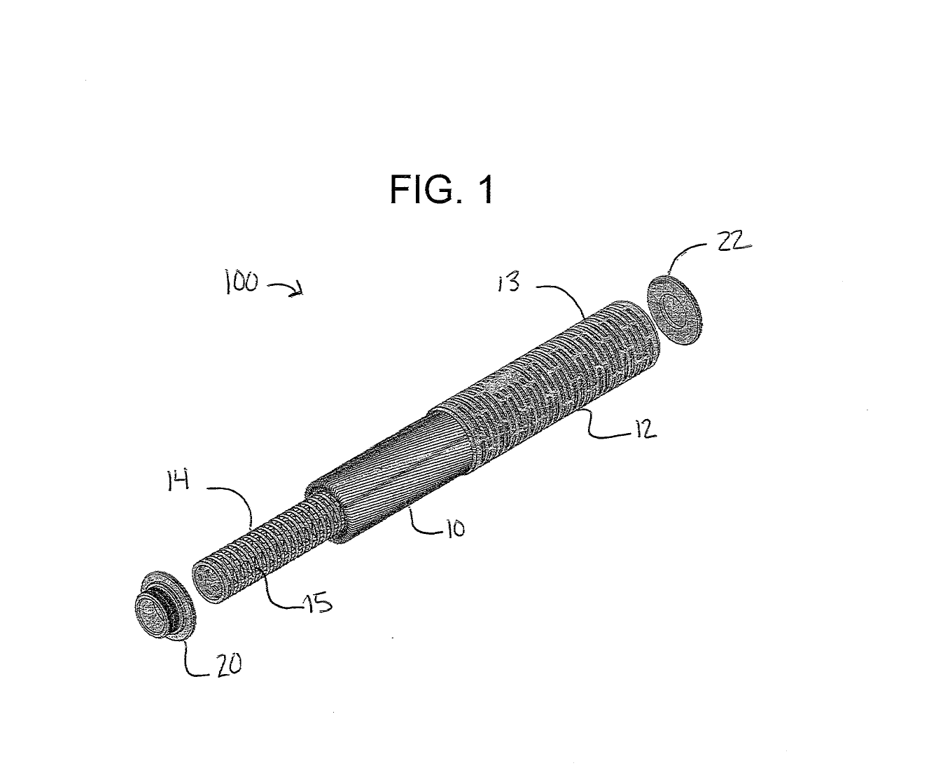

FIG. 1 is an illustration of a filtration article 100 according to one or more embodiments of the invention that may be constructed wholly of fluoropolymer materials and which may be sized for positioning within a filtration capsule (not shown). The filtration article 100 includes an outer cage 12 that has a plurality of apertures 13 through the surface of the outer cage 12 to enable fluid flow through the outer cage 12, e.g., laterally through the surface of the outer cage 12. A filtration medium 10 to filter unwanted particulates from a fluid stream is concentrically disposed within the outer cage 12. The filtration material 10 has a twisted configuration. In addition, an inner core member 14 is disposed within the cylindrical filtration medium 10. The inner core member 14 is also substantially cylindrical and includes apertures 15 to permit a fluid stream to flow through the inner core member 14, e.g., laterally through the surface of the inner core member 14. Thus, the filtration medium 10 is disposed between the inner core member 14 and the outer cage 12.

The filtration device 100 further includes end cap components 20, 22 disposed at opposite ends of the filtration cartridge 100. The end cap components 20, 22 may include apertures (not illustrated) to permit fluid communication with the inner core member 14. Thus, fluid may flow into the filtration cartridge 100 through the apertures and into the inner core member 14. Under sufficient fluid pressure, fluid will pass through apertures 15, through the filtration medium 10, and exit the filtration cartridge 100 through the apertures 13 of the outer cage 12.

When the filtration cartridge 100 is assembled, the end cap components 20, 22 are potted onto the filtration medium 10 with the outer cage 12 and the inner core member 14 disposed between the end cap components 20, 22. The end cap components 20, 22 may be sealed to the filtration medium 10 by heating the end cap components 20, 22 to a temperature that is sufficient to cause the thermoplastic from which the end cap components are fabricated to soften and flow. When the thermoplastic is in a flowable state, the ends of the filtration medium 10 are contacted with the respective end cap components 20, 22 to cause the flowable thermoplastic to imbibe (e.g., to infiltrate) the filtration medium 10. Thereafter, the end cap components 20, 22 are solidified (e.g., by cooling) to form a seal with the filtration medium 10. The assembled filtration cartridge 100 (e.g., with the end cap components potted onto the filtration medium) may then be used in a filtration device such as a filtration capsule.

It is to be appreciated that various other configurations of filtration devices may be utilized in accordance with the present disclosure, such as non-cylindrical (e.g., planar) filtration devices. Further, although the flow of fluid is described as being from the outside of the filtration cartridge to the inside of the filtration cartridge (e.g., outside-in flow), it is also contemplated that in some applications fluid flow may occur from the inside of the filtration cartridge to the outside of the filtration cartridge (e.g., inside-out flow).

The filtration medium 10 includes at least a first layer of a porous membrane (e.g. a porous fluoropolymer membrane) and at least one fibrous layer that is configured to support the porous membrane and/or is configured to provide drainage of fluid away from the membrane. The filtration medium 10 further includes a thermoplastic material that is imbibed (e.g., infiltrated) within the filtration medium 10 along at least one end of the filtration medium 10. Further, one or both ends of the porous membrane and fibrous layer of filtration article 100 may be potted to sealably interconnect the end(s) of the filtration medium 10.

The porous membrane within the filtration medium is configured to separate particles from a fluid stream when the porous membrane is positioned in the fluid stream, For example, the porous membrane may have a pore size and pore size distribution that is configured to remove particles from the fluid stream. It is to be appreciated that the porous membrane may include a single membrane layer or multiple membrane layers. In one or more embodiments, the porous membrane is a fluoropolymer membrane such as, for example, a polytetrafluoroethylene (PTFE) membrane or an expanded polytetrafluoroethylene (ePTFE) membrane. Expanded polytetrafluoroethyene (ePTFE) membranes prepared in accordance with the methods described in U.S. Pat. No. 7,306,729 to Bacino et al., U.S. Pat. No. 3,953,566 to Gore, U.S. Pat. No. 5,476,589 to Bacino, or U.S. Pat. No. 5,183,545 to Branca et al. may be used herein.

The porous membrane may also include an expanded polymeric material comprising a functional tetrafluoroethylene (TFE) copolymer material having a microstructure characterized by nodes interconnected by fibrils, where the functional TFE copolymer material includes a functional copolymer of TFE and PSVE (perfluorosulfonyl vinyl ether), or TFE with another suitable functional monomer, such as, but not limited to, vinylidene fluoride (VDF). The functional TFE copolymer material may be prepared, for example, according to the methods described in U.S. Patent Publication No. 2010/0248324 to Xu et al. or U.S. Patent Publication No. 2012/035283 to Xu et al. It is to be understood that throughout the application, the term “PTFE” is meant to include not only polytetrafluoroethylene, but also expanded PTFE, expanded modified PTFE, and expanded copolymers of PTFE, such as described in U.S. Pat. No. 5,708,044 to Branca, U.S. Pat. No. 6,541,589 to Baillie, U.S. Pat. No. 7,531,611 to Sabol et al., U.S. Patent Publication No. 2009/0093602 to Ford, and U.S. Patent Publication No. 2010/0248324 to Xu et al.

The fibrous layer in the filtration medium includes a plurality of fibers (e.g., fibers, filaments, yarns, etc.) that are formed into a cohesive structure. The fibrous layer is positioned adjacent to and downstream of the porous membrane to provide support for said porous membrane. The fibrous layer may be a woven structure, a nonwoven structure, or a knit structure. In one particular embodiment, the fibrous layer is a knit structure. The fibrous layer may provide support for the porous membrane and/or may provide fluid drainage for the filtration medium 10. The fibrous layer may be formed of fibers or strands of fluoropolymers, such as polytetrafluoroethylene (PTFE), fluorinated ethylene propylene (FEP), perfluoroalkoxy alkane (PFA), and polyvinylidene fluoride (PVDF). In one or more embodiments, the fiber layer includes PTFE fibers, such as, for example, a PTFE knit layer.

As discussed above, the filtration material also contains a thermoplastic material. The thermoplastic material may be imbibed through at least a portion of a thickness of the fibrous layer and along at least a first peripheral edge of the filtration medium 10. The thermoplastic material may also be imbibed along a second peripheral edge of the filtration medium 10 where the second peripheral edge is on an opposite side of the filtration medium 10 from the first peripheral edge. Suitable thermoplastic materials for use in the filtration medium 10 include, but are not limited to, fluorinated ethylene propylene (FEP), perfluoroalkoxy alkane (PFA), polyvinylidene fluoride (PVDF), perfluoro methyl alkoxy (MFA), and a terpolymer of TFE, hexafluoropropylene and vinylidene fluoride (THV). In at least one exemplary embodiment, the thermoplastic material is FEP or PFA.

Optionally, the filtration material may include a second fibrous layer, such as a knit structure, that is fabricated from strands of a fluoropolymer material such as PTFE. The fibrous structure in this second fibrous layer may be substantially similar to the fibrous structure in the first fibrous layer. The second fibrous layer may be disposed on an opposite side of the first fibrous layer such that the membrane layer is positioned between the two fibrous layers. The thermoplastic material may be imbibed through the first and second fibrous layers. In one embodiment, one of the fibrous layers provides support for the membrane layer while the other fibrous layer provides a drainage function to facilitate drainage of fluid away from the membrane layer.

The components of the filtration device 100 (e.g., a filtration cartridge) including the outer cage 12, the inner core member 14, and the end cap components 20, 22 may be fabricated from a fluoropolymer, and in particular, may be fabricated from a thermoplastic fluoropolymer. Non-limiting examples of suitable thermoplastic fluoropolymers such as perfluoroalkoxy alkane (PFA), fluorinated ethylene propylene (FEP), ethylene tetrafluoroethylene (ETFE), polychlorotrifluoroethylene (PCTFE), ethylene chlorotrifluoroethylene (ECTFE), and polyvinylidene fluoride (PVDF). It is to be noted that fluoropolymers are particularly useful for the filtration of chemically corrosive fluids, such as during semiconductor manufacture.

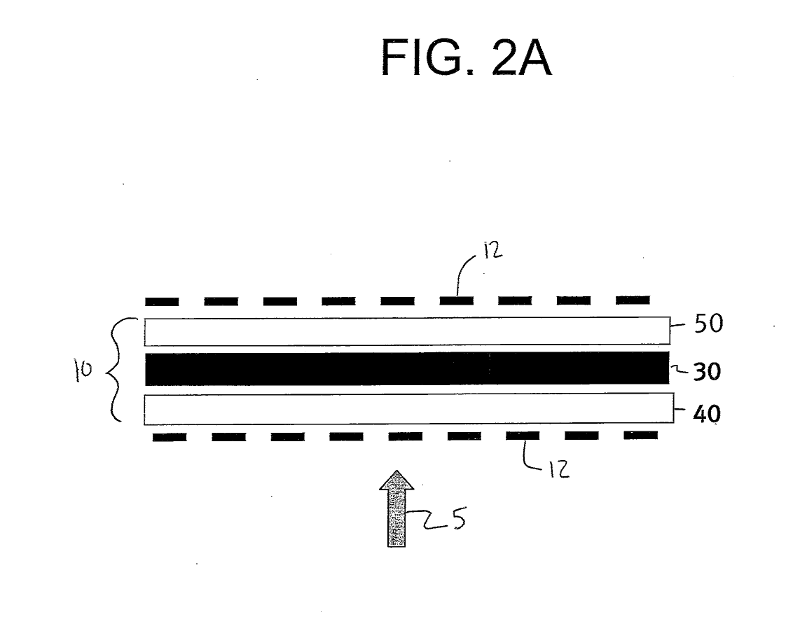

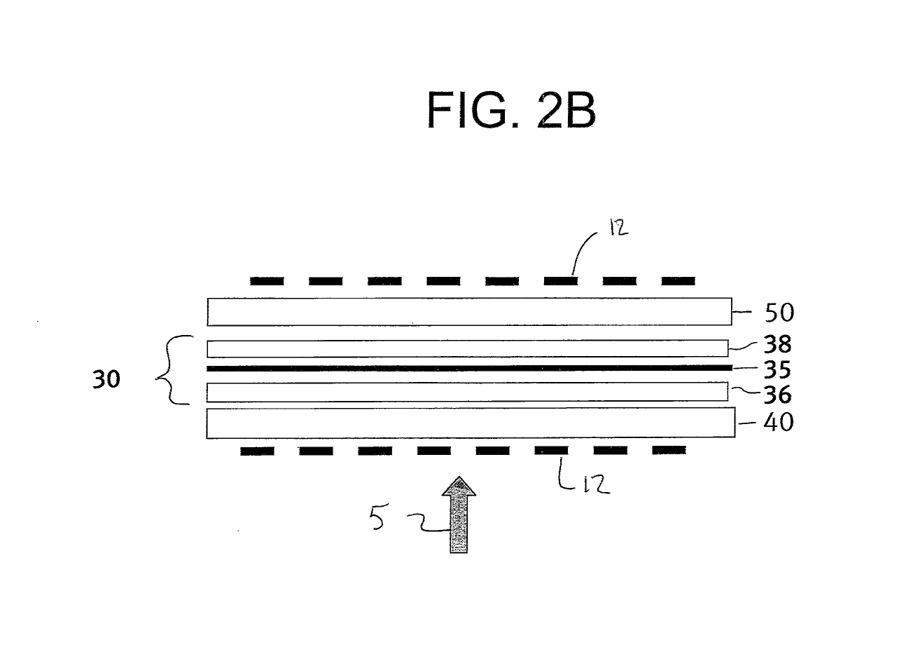

FIG. 2A depicts one exemplary orientation of the layers of materials forming the filtration material 10. As shown, the filtration medium 10 may include a porous membrane 30, a first fibrous layer 40 forming an upstream drainage layer and a second fibrous layer 50 forming a downstream drainage layer. The arrow 5 depicts the direction of fluid flow through the filtration material 10.

In one exemplary embodiment, the first fibrous layer 40 may include a perfluoroalkoxy alkane (PFA) woven layer and the second fibrous layer 50 may include a knit made of polytetrafluoroethylene fibers, such as those made in accordance with the teachings of U.S. Publication No. 2014/0021145 to Propst, et al. As shown in FIG. 2B, the porous membrane 30 may include multiple membrane layers, such as, for example, a middle layer 35 and outer layers 36, 38. In one exemplary embodiment, middle layer 35 includes an expanded functional fluoropolymer membrane including a copolymer of tetrafluoroethylene (TFE) and perfluoro-3,6-dioxa-4-methyl-7-octene-sulfonyl fluoride (PSVE) made generally according to the teachings of U.S Patent Publication No. 2012/035283 to Xu et al. and outer layers 36, 38 include expanded polytetrafluoroethylene (ePTFE) membranes that may be made generally according to the teachings of U.S. Pat. No. 5,814,405 to Branca, et al. Outer layer 38 may be attached to the second fibrous layer 50 (e.g., downstream drainage layer) by using conventional heat and/or pressure lamination techniques.

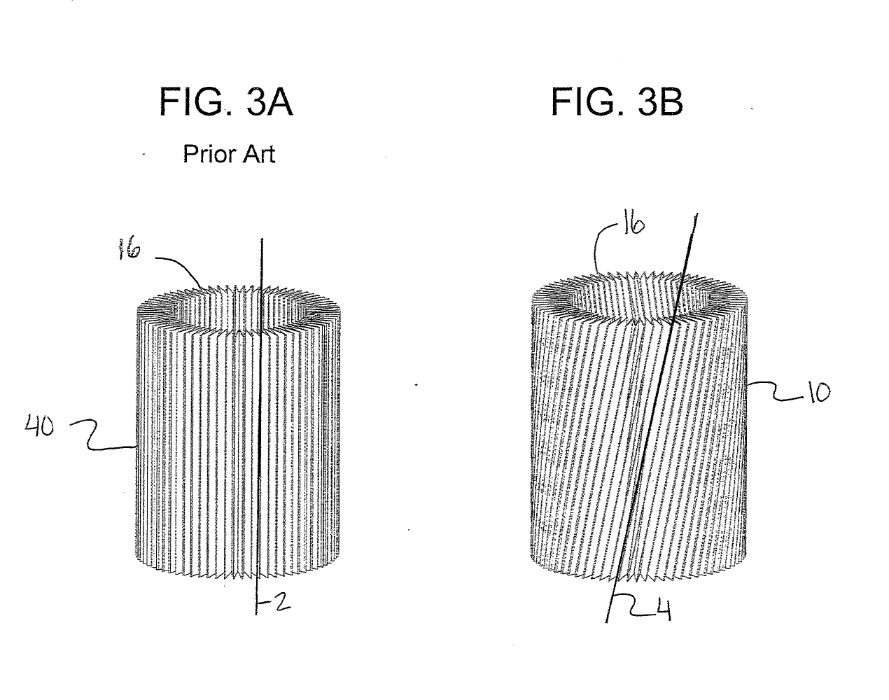

The utilization of a pleated configuration in filtration articles provides for increased filtration capacity by increasing the operative size of filtration material 10. As shown generally in FIG. 1, the pleats within the filtration material 10 have a non-linear orientation within the filtration cartridge 100. FIG. 3A depicts a conventional filtration material 40 with pleats 16 that expand linearly along a longitudinal axis and are substantially straight from end to end of the filtration material 40. Turning to FIG. 3B, it can be seen that the inventive pleated filtration material 10 has a generally cylindrical or tubular configuration with pleats 16 (e.g., outwardly projecting pleats) having an inverted V-shaped configuration that are positioned about and extend non-linearly from end to end of the filtration material 10. Lines 2, 4 generally depict the orientation of the pleats in the filtration material of FIG. 3A and FIG. 3B, respectively. The pleats 16 define V-shaped regions, or valleys, between adjacent ones of the pleats 16. It is to be appreciated that other types and/or shapes of pleats may be used instead of, or in conjunction with, a pleat that has a generally V-shaped configuration, and that such pleats and pleat forms are considered within the purview of the invention.

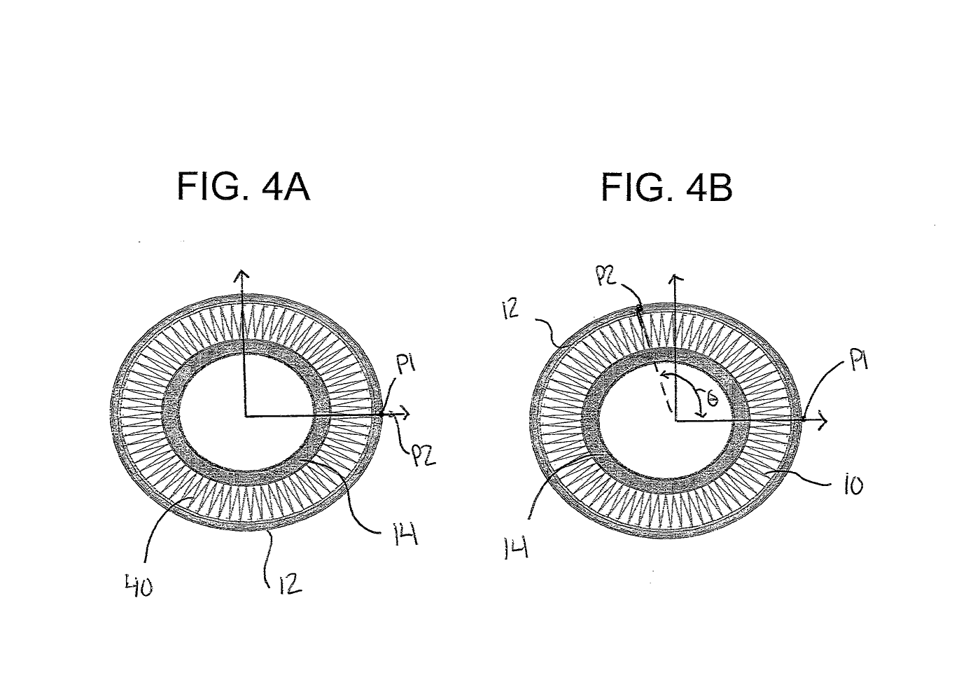

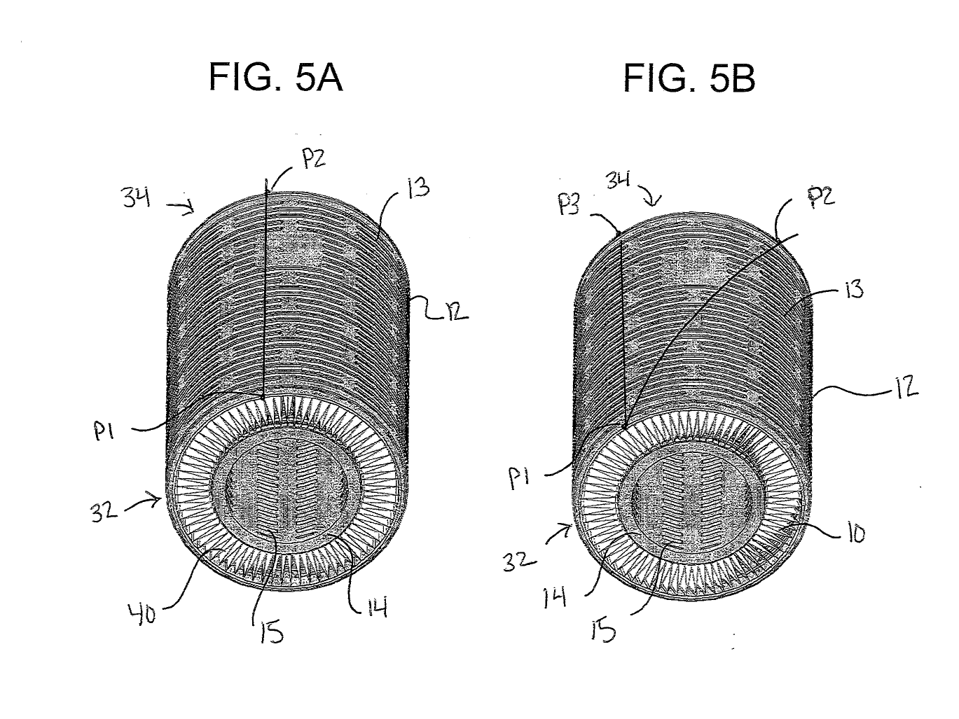

In forming a twisted or rotated pleated filtration material in accordance with at least one embodiment of the invention, a first end of a pleated filtration material where the pleats have a linear or substantially linear orientation is immobilized and a second end of the pleated filtration material is rotated about its longitudinal axis. Alternatively, both the first and second ends of the filtration material may be simultaneously rotated in opposing directions. As shown schematically in FIGS. 4A and 5A, prior to twisting, a pleat within a filtration device 100 has the same position at the first end 32 and the second end 34 of the filtration device 100. Thus, the first position and second position of the pleat are at the same location (or substantially the same location) along the longitudinal axis. After the filtration material 10 has been rotated a desired amount, the pleat no longer has the same position at the first and second ends 32, 34 within the filtration device 100 such as is shown in FIGS. 4B and 5B. FIGS. 4B and 5B illustrate that as the filtration material 10 is rotated within the filtration device 100, the position of the pleat at the second end 34 moves about the circumference of the filtration device 100 from the first position (P1) to a second position (P2).

The angle of rotation (θ) of the filtration material may be determined by measuring the angle θ that is formed from imaginary axis lines stemming from the center of the filtration device 100 to (1) the location of the pleat at the first end 32 of the filtration device 100 (P1) and (2) to the location of the same pleat at the second end 34 of the filtration device 100 (P2) as shown in FIG. 4B. The angle of rotation (θ) may be measured with a suitable measuring device, such as with a protractor, or it may be visually estimated. The angle of rotation may range from about 5 degrees to about 1440 degrees, from about 5 degrees to about 180 degrees, from about 10 degrees to about 540 degrees, from about 15 degrees to about 360 degrees, or from about 20 degrees to about 180 degrees. Alternatively, the angle of rotation may be greater than about 5 degrees, greater than about 10 degrees, greater than about 20 degrees, greater than about 180 degrees, greater than about 360 degrees, greater than about 540 degrees, or greater than about 1440 degrees, or even greater. It is to be noted that because the filtration material 10 depicted in FIG. 4A has not been twisted, the angle of rotation is zero. It is to be noted that the amount of rotation of the filtration material 10 is at least partially dependent upon the packing density of the pleated filtration material 10 and/or the thickness of the pleated filtration material 10.

In another embodiment, the angle of rotation (θ) may be calculated by using the following equation:

$$θ = 114.6 \sqrt{\frac{{L}_{m}^{2} - {L}_{c}^{2}}{{d}^{2}}}$$

where Lₘ is the length of the total filtration material 10 in the filtration device caused by twisting or rotating the filtration media, L_{c} is the length of the filtration device 100, and d is the diameter of the filtration material 10. The additional material added to the filtration device may be determined by Lₘ−L_{c}, i.e., the twisted length minus the untwisted length.

Turning to FIG. 5B, to determine the length Lₘ, a designated pleat within the filtration material 10 at the first end 32 of the filtration cartridge 100 is identified as P1. The position of the same pleat at the second end 34 of the filtration cartridge 100 is identified as P3. The filtration material 10 is then twisted as described above, thereby repositioning the position of the designated pleat at the second end 34 of the filtration cartridge 100 to P2. The length (Lₘ) of the filtration material 10 in the filtration device 100 is the distance from P1 to P3. This length may be determined by removing the pleated filtration material 10 from the filtration device 100 and measuring the physical distance from P1 to P3. This distance from P1 to P3 (i.e., Lₘ) correlates to the total amount of filtration material 10 included in the filtration device 100 by twisting or rotating the filtration medium.

Increasing the effective amount of filtration material 10 in the filtration device 100 corresponds to an increase in the Effective Filtration Area (EFA). The EFA of the filtration device may be at least 10%, at least 20%, at least 30%, or even greater. For example, a filtration material having a non-twisted, substantially linear pleat orientation with a length of 23 cm and a width of 1372 cm has an EFA of 31556 cm² (EFA=L times W). In contrast, the same filtration material that is twisted and having a length of 25 cm and an identical width of 1372 cm, has an EFA of 34500 cm². Thus, in this hypothetical example, the twisted, pleated filtration material has about a 9.3% increase in EFA compared to the same filtration device without rotating (twisting) the filtration material.

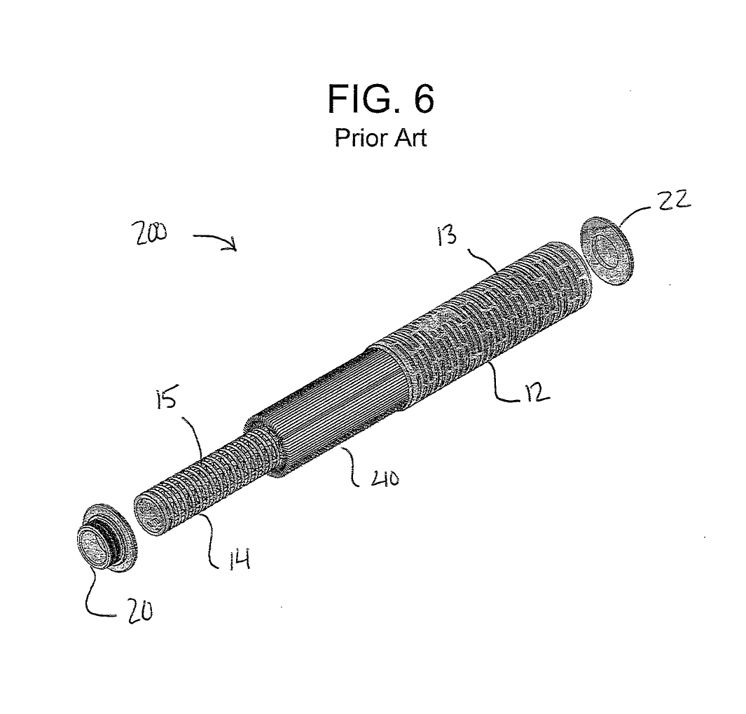

As described herein, and as illustrated in at least FIG. 1, the pleats within the filtration material 10 have non-linear orientation within the filtration cartridge 100. In contrast, conventional pleated filtration materials 40 in a conventional filtration cartridge 200 have a linear or substantially linear orientation as is shown in FIG. 6. It is to be noted that in forming the conventional filtration device 200, the pleated filtration material 40 may become buckled or wavy within the filtration cartridge 200 and, as a result, may not be perfectly linear in its orientation within the cartridge 200.

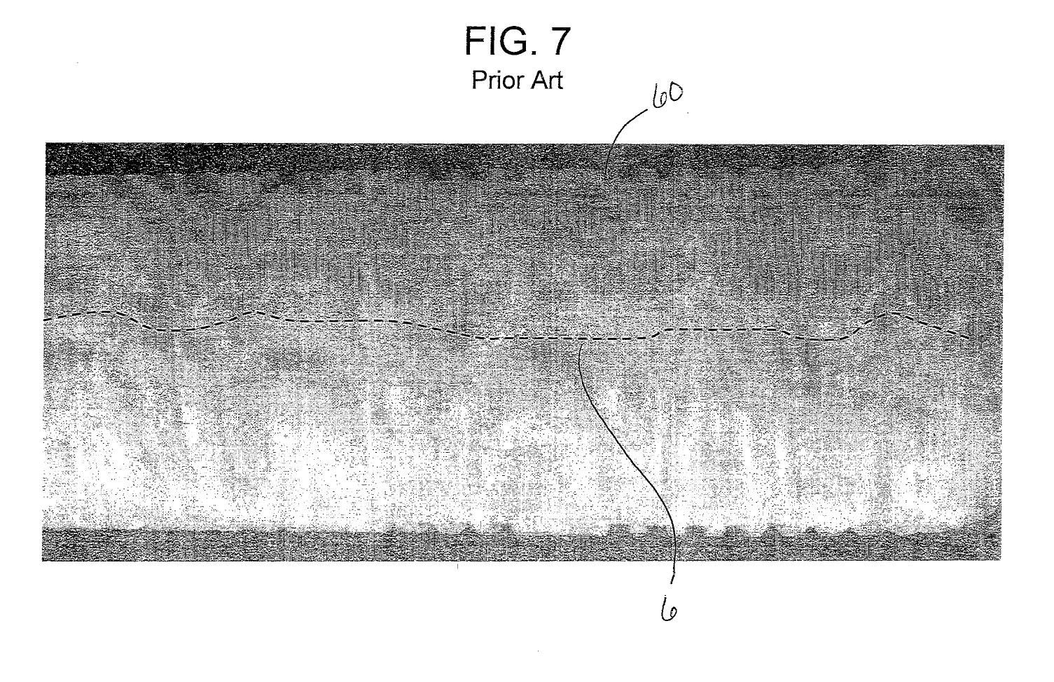

The buckling of a conventional filtration material 40 is depicted in FIG. 7 by the dashed line 6 superposed on a buckled pleat within the cartridge 60. As a result, there may be some unintentional slight misalignment of the pleats within the filtration material 40. The buckling within the filtration device 200 and subsequent distortion of the filtration material 40 is at least partially due to the inability of the filtration material 40 to maintain its shape (e.g., lack of rigidity of the filtration material) while it is being placed into the outer cage 12, and often collapses as the filtration material 40 is forced into the outer cage.

In contrast, the intentional misalignment of pleats achieved in the present invention by twisting or rotating the filtration material 10 removes and/or prevents the buckling, folding, or other distortion of the filtration material that occurs in conventional devices. It has also been determined that by twisting the filtration material 10 while simultaneously loading the filtration material 10 into the outer cage 12 makes it easier to load the filtration material 10 into the cage 12. Additionally, when the filtration material 10 is twisted, the column strength of the pleated material 10 in the filtration device 100 is significantly increased.

When an axial load is applied to a filtration material that is not twisted, the resistance of the pleats to buckling and deformation is a function of the strength of the filtration material, and the proximity of adjacent pleats. Twisting the filtration material brings adjacent pleats into contact with one another, providing load transfer of an axially applied load between adjacent pleats and reducing or eliminating the space between pleats in which buckling could otherwise occur. Accordingly, a twisted filtration material is more resistant to deformation and buckling under an applied axial load compared to a non-twisted filtration material when loading the filtration material into a filtration device (e.g., outer cage member).

When the filtration material 10 is manufactured and subsequently inserted into an outer cage 12, excess material 10 extends from each end of the outer cage 12. This excess filtration material 10 is removed prior to the cage 12 being placed in the filtration cartridge 100. It has been determined that the twisted, pleated filtration material 10 greatly improves the cutting ability of the material 10. The intentional twisting of the filtration material according to the present invention forms a rigid or semi-rigid filtration material (e.g., pleat pack) that prevents the collapse of the filtration material 10 as the material 10 is being cut. Additionally, the quality of the trim cut is greatly improved with the twisted, pleated filtration material 10 compared to a conventional, non-twisted pleated filtration material. In particular, the trim cut is even or substantially even across the end of the filtration material. The substantially uniform surface of the trim cut of the filtration material results in a uniform or substantially uniform heating of the thermoplastic material located in the outer edges of the filtration material. In addition, the uniformity of the surface and even or near even heating of the thermoplastic material at the cut end of the filtration material enables all or nearly all of the pleats to be in contact with the end cap during the embedding process, resulting in an improved filter cartridge. The ease of loading, improved cutting ability, and improved quality of trim cut decreases manufacturing time and enhances the quality of the final filtration cartridge.

It is to be appreciated that the intentional rotation of the filtration material applies to any filtration material, regardless of shape, strength, and/or thickness of the layers within the filtration material and/or pleats, and/or diameter of the filtration device. For instance, thin or weak layers in the filtration material benefit from the twisting of the filtration material because, as discussed herein, the stiffness (rigidity) of the filtration material increases with the twisting of the material. As a result, the filtration material may be handled and/or cut with ease. Additionally, tall pleats are able to support themselves against an applied pressure due to the twisting of the filtration material. In multi-level V-shaped pleat geometries, twisting of the filtration material allows the multi-levels within the pleats to come into contact with one another, thereby creating improved support for each individual pleat. In the case of geometries where certain pleats are not extant from outer diameter of the inner core member to the inner diameter of the outer cage, the additional support provided by rotating the filtration material aids helps the pleats to resist deformation and dislocation when a pressure is applied across the filter material.

Also, as the diameter of the filtration device increases, the twisting of the filtration material may aid in the loading and cutting of material in these larger filtration devices. Further, the twisting of the filtration material in a filtration device that has a large diameter and/or a large length may increase the EFA.

### EXAMPLES

### Example 1

### Non-Twisted Filtration Material

A filtration medium 25.4 cm long and 798 cm wide having a layered configuration as shown in FIG. 2B and described in detail above was constructed. The filtration material included a first end, a second opposite end, and had a cylindrical, tubular configuration with outwardly projecting pleats of an inverted V-shaped configuration positioned about and extending along a longitudinal axis of the filtration material.

The filtration material was inserted into a perforated outer cage having therein an inner perforated core member. The inner diameter (d) and length of the cage (L_{c}) were measured to be 7.6 cm and 25.4 cm, respectively.

A pleat at the first end of the pleat pack was arbitrarily chosen and marked (P1) using a marking pen. The corresponding edge of the same pleat at the second end of the outer cage was located and marked (P2). It was noted that the mark at the first end (P1) and the second end (P2) were aligned along the longitudinal axis of the filtration material, such as is shown in FIG. 5A. A cross-sectional end view of the filtration material depicting the location of both ends P1, P2 at the same position showed a configuration similar to that depicted in FIG. 4A. The filtration device had an Effective Filtration Area (EFA) of 20268 cm².

### Example 2

### Twisted Filtration Medium

The first end of the filtration material of Example 1 was immobilized while the second end was rotated clockwise about the longitudinal axis until a point wherein the filtration material was unable to be rotated any further. The twisting of the filtration material gave the material a helical-like shape, similar to that shown in FIG. 3. Once the filtration material had been rotated, the pleat designated at P1 at the first end of the outer cage was followed along its path within the cage to its location at the second end of the outer cage. The rotated location of the pleat was marked P2 with a marking pen. It was noted that P1 was not aligned with P2. The shift in location of the pleat edge from P1 to P2 was similar to that shown in FIG. 5B. A cross-sectional end view of the twisted, pleated filtration material was similar to that shown in FIG. 4B. In contrast with the non-twisted filtration material of the comparative example shown in FIG. 5A where the first and second end positions P1, P2 were linearly aligned along the longitudinal axis of the filtration material, the end positions P1, P2 of the pleats in the twisted filtration material were not linearly aligned along the longitudinal axis of the filtration material as shown in FIG. 5B.

The degree of twist may be described geometrically by the angle of rotation θ, using the following procedure. After the pleat edge of the twisted filtration material at the second end was marked P2, the filtration material was rotated counter clockwise to such that P2 was aligned with P1 along the vertical axis of the outer cage. The angle of rotation was visibly estimated to be approximately 180 degrees by estimating the angle that was formed from imaginary axis lines stemming from the center of the filtration device to (1) P1 and (2) P2, similar to that shown in FIG. 4B.

The angle of rotation was also calculated using the following equation:

$$θ = 114.6 \sqrt{\frac{{L}_{m}^{2} - {L}_{c}^{2}}{{d}^{2}}}$$

The actual length (Lₘ) of material in the cartridge was be determined by removing the filtration material from the outer cage and measuring the distance between P1 and P2. The length of the filtration material was 28.1 cm. The inner diameter (d) and length of the cage (L_{c}) were measured to be 7.6 cm and 25.4 cm, respectively. The Effective Filtration Area was determined to be 22406 cm².

Next, the difference in length between the distance from P1 to P2 (i.e., Lₘ) (marked in the Comparative Example) and the distance from P1 to P3 (i.e., L_{c}) was determined to be 2.7 cm. This was the effective increase in length of the filtration material in the filtration cartridge, which was calculated to be an increase in effective filtration area (EFA) of the twisted, pleated filtration material of about 10.5% compared to the filtration material in an untwisted configuration.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A filter cartridge assembly comprising:
an outer cage;
a filtration material having a cylindrical configuration concentrically positioned within said outer cage, said filtration material including:
a first end;
a second end opposing said first end; and
outwardly projecting pleats;
an inner core member disposed within said filtration material; and
an end cap bonded to each said first and second ends of said cylindrical filtration material,
wherein a pleat has a first position on said first end surface and a second position on said second end surface, and
wherein said second position is not in alignment with said first position along a longitudinal axis of said filtration material.

2. The filtration cartridge assembly of claim 1, wherein said pleats have an angle of rotation from about 5 degrees to about 1440 degrees.

3. The filtration cartridge assembly of claim 1, wherein said pleats have a substantially V-shaped configuration.

4. The filtration cartridge assembly of claim 1, wherein said filtration material comprises:
a porous membrane; and
a fibrous layer configured to support said porous membrane, said fibrous layer comprising a plurality of fibers arranged in a cohesive structure.

5. The filtration cartridge assembly of claim 4, wherein said porous membrane is selected from polytetrafluoroethylene and expanded polytetrafluoroethylene.

6. The filtration cartridge assembly of claim 4, wherein said cohesive structure comprises a woven structure, a non-woven structure, or a knit structure.

7. The filtration cartridge assembly of claim 1, wherein said filtration material increases an effective filtration area of said filtration material by at least about 10%.

8. A filter cartridge assembly comprising:
a cylindrical filtration material having pleats, said cylindrical filtration material defining an outer periphery, an inner periphery, a first end surface, and a second end surface; and
an end cap bonded to each said first and second end surface of said cylindrical element,
wherein said pleats have an angle of rotation (θ) greater than about 5 degrees as calculated utilizing the following formula:
$$θ = 114.6 \sqrt{\frac{{L}_{m}^{2} - {L}_{c}^{2}}{{d}^{2}}}$$
where Lₘ is length of said filtration material,
where L_{c} is length of filter cartridge, and
where d is diameter of said filtration material.

9. The filtration cartridge assembly of claim 8, wherein said ends of said pleats have an angle of rotation from about 5 degrees to about 1440 degrees.

10. The filtration cartridge assembly of claim 8, wherein said pleats have a substantially V-shaped configuration.

11. The filtration cartridge assembly of claim 8, wherein said filtration material comprises:
a first layer comprising a porous fluoropolymer membrane;
a second layer comprising a plurality of fluoropolymer fibers arranged to form a fibrous structure, said fibrous structure being selected from a woven structure, a nonwoven structure, and a knit structure; and
a thermoplastic material through at least a portion of a thickness of said fibrous layer and along at least a first peripheral edge of said filtration material.

12. The filtration cartridge assembly of claim 8, wherein said filtration material increases an effective filtration area of said filtration material by at least about 10%.

13. A method of forming a twisted, pleated filtration material comprising:
twisting a first end of filtration material relative to a second end of said filtration material, said filtration material comprising a plurality of pleats; and
calculating a twist angle formed between a first position of a designated pleat and a second position of said designated pleat utilizing the following formula:
$$θ = 114.6 \sqrt{\frac{{L}_{m}^{2} - {L}_{c}^{2}}{{d}^{2}}}$$
where Lₘ is length of filtration material,
where L_{c} is length of filter cartridge, and
where d is diameter of filtration material,

14. The method of claim 13, wherein said filtration material comprises:
a first layer comprising a porous fluoropolymer membrane;
a second layer comprising a plurality of fluoropolymer fibers arranged to form a fibrous structure, said fibrous structure being selected from a woven structure, a nonwoven structure, and a knit structure; and
a thermoplastic material through at least a portion of a thickness of said fibrous layer and along at least a first peripheral edge of said filtration material.

15. The method of claim 13, wherein said pleats have a substantially V-shaped configuration.

16. The method of claim 13, wherein said ends of said pleats have an angle of rotation from about 5 degrees to about 1440 degrees.

17. A method of forming a twisted filtration material comprising:
obtaining a cylindrical filter element including:
a first end surface;
a second end surface opposing said first end surface; and
outwardly projecting pleats, each said pleat having a first position on said first end surface and a second position on said second end surface, said first and second positions being substantially in alignment with a longitudinal axis of said filtration material; and
rotating said second end surface relative to said first end surface about said vertical axis,
wherein after said rotation, said first position is not in alignment with said second position along said longitudinal axis of said filtration material.

18. The method of claim 17, wherein prior to rotating, said pleats have a substantially V-shaped configuration positioned about and extending along a longitudinal axis of said filtration material.

19. The method of claim 17, wherein said ends of said pleats have an angle of rotation from about 5 degrees to about 1440 degrees.
